(19) United States
(12) Patent Application Publication
(10) Pub. No.: US 2006/0255315 A1
(43) Pub. Date: Nov. 16, 2006

(54) Selective removal chemistries for semiconductor applications, methods of production and uses thereof

(76) Inventors: Deborah L. Yellowaga, Phoenix, AZ (US); Ben Palmer, Phoenix, AZ (US); John S. Starzynski, Brooklyn Park, MN (US); John A. McFarland, Scottsdale, AZ (US); Marie Lowe, Gilbert, AZ (US)

Correspondence Address: Buchalter Nemer;A Professional Corporation, Suite 800, 18400 Von Karman, Irvine, CA, 92612, US

(21) Appl. No.: 11/352,124

(22) Filed: Feb. 10, 2006

Related U.S. Application Data
(63) Continuation-in-part of application No. PCT/US04/38761, filed on Nov. 19, 2004.

(51) Int. Cl. C09K 13/00; B44C 1/22; C23F 1/00

(52) U.S. Cl. 252/79.1; 252/79.3; 216/83

(57) ABSTRACT

Removal chemistry solutions and methods of production thereof are described herein that include at least one fluorine-based constituent, at least one chelating component, surfactant component, oxidizing component or combination thereof, and at least one solvent or solvent mixture. Removal chemistry solutions and methods of production thereof are also described herein that include at least one low H₂O content fluorine-based constituent and at least one solvent or solvent mixture.

This application is a Continuation-in-Part of PCT Application Serial No. PCT/US04/38761 (National Application) filed in the US Receiving Office on Nov. 19, 2004, which designates the United States. PCT Application Serial No. PCT/US04/38761 is commonly-owned with this application and is incorporated herein in their entirety by reference.

### FIELD OF THE SUBJECT MATTER

The field of the subject matter is selective removal chemistries for semiconductor, electronic and related applications.

### BACKGROUND

To meet the requirements for faster performance, the characteristic dimensions of features of integrated circuit devices have continued to decrease. Manufacturing of devices with smaller feature sizes introduces new challenges in many of the processes conventionally used in semiconductor fabrication. Dual damascene patterning and via first trench last (VFTL) copper dual damascene patterning through a low dielectric constant (less than about 3) material or ultra low dielectric constant (less than about 2) material is one of these manufacturing methods. Two examples of dual damascene patterning and structures are shown in US Patent Publications 20040152296 and 20040150012—both assigned to Texas Instruments. In the manufacture of MEMS (microelectromechanical systems) devices, each continuous or patterned layer comprises deleterious residues that, if left even partially intact, will contribute to the breakdown and ultimately the failure of any component that comprises that layer. Therefore, it is imperative that any deleterious residues produced during the manufacture of semiconductor, MEMS and other electronic devices be removed effectively and completely. In addition, where one or more layers need to be etched, the etch pattern should be precise and the removal chemistry solution used should be selective to the layer being etched. Prior Art FIGS. 1A-1C show ash residues in a via clean (Prior Art FIG. 1A), a trench clean (Prior Art FIG. 1B) and an etch stop clean (Prior Art FIG. 1C) application. Prior Art FIG. 1A, shows a layered material 100 that comprises a polymer sidewall 110 and ash residues 120. Prior Art FIG. 1B shows a layered material 200 that comprises a polymer sidewall 210, ash residues 220, a via fence 230 and a via fill 240. The via fence 230 and/or via fill 240 may or may not be present depending on the integration scheme. Prior Art FIG. 1C shows a layered material 300 that comprises a polymer sidewall 310, ash residues 320, a via fence 330 and copper oxide and/or copper fluoride residues 350. Prior Art FIGS. 2A-2C show etch residues, including sidewall polymers, antireflective coatings and other residues, in a via clean (FIG. 2A), a trench clean (FIG. 2B) and an etch stop clean (FIG. 2C) application. Prior Art FIG. 2A, shows a layered material 400 that comprises a polymer sidewall 410, a photoresist layer 420 and an antireflective coating layer 430. Prior Art FIG. 2B shows a layered material 500 that comprises a polymer sidewall 510, antireflective coating 520, a via fill 525, a via fence 530, which may or may not be present depending on the integration scheme, and a photoresist 540. The via fence 230 and/or via fill 240 may or may not be present depending on the integration scheme. Prior Art FIG. 2C shows a layered material 600 that comprises a polymer sidewall 610, a via fence 630 and Copper oxide and/or Copper fluoride residues 650. Prior Art FIG. 3 shows a layered material 700 that comprises a UV exposed and developed photoresist 705, a BARC (Bottom Anti-Reflective Coating) 710, wherein the BARC, which may be organic or inorganic, needs to be removed without impacting critical dimensions.

The technique of bulk residue removal by means of a selective chemical etching and in some cases selective chemical cleaning is a key step in the manufacture of many semiconductor and electronic devices, including those mentioned. The goal in successful selective etching and selective cleaning steps is to remove the residue without removing or compromising the desirable components. In some cases, the “removal” of unwanted materials or residues includes reacting those unwanted materials with solutions or compounds in order to convert those unwanted materials into materials that are not harmful or have negative impact on the electronic or semiconductor applications or components.

Each class of semiconductor and electronic materials comprise different chemistries that should be considering when developing the removal chemistry and in several cases, these semiconductor and electronic materials have also been modified to increase removal selectivity, such as the etch selectivity or the cleaning selectivity. If the chemistry of the sacrificial layer cannot be modified in order to improve the removal selectivity, then removal chemistry solutions should be developed to specifically react with the chemistry of the sacrificial material. However as mentioned, not only does the chemistry of the sacrificial material need to be evaluated and considered, but also the chemistry of the surrounding and/or adjacent layers should be considered, because in many instances, the chemistry that will remove the sacrificial layer or layers will also remove or weaken the surrounding or adjacent layers.

Several of the goals that have yet to be addressed in a selective removal chemistry solution are the following: a) the solution constituents should be able to be tailored to be a selective etching solution and/or a selective cleaning solution; b) the solution should be effective in a low H₂O content environment or an anhydrous environment; c) should be able to selectively remove deleterious materials and compositions from a surface without removing the layers and materials that are crucial to product success; and d) can etch and/or clean effectively at the center of the wafer or surface and at the edge of the wafer or surface.

European Patent No. 887,323 teaches an etching and cleaning solution that comprises hydrofluoric acid and ammonium fluoride in propylene carbonate. This etching solution is specifically designed to etch silicate glass and silicon dioxide. Based on the chemistry disclosed, it appears that this combination of constituents is selective to silicate glass and silicon dioxide. JP 9235619 and U.S. Pat. No. 5,476,816 uses a similar solution replacing propylene carbonate with ethylene glycol in order to remove insulating coatings. JP 10189722 uses a similar solution as JP 9235619 except water is also added and the solution is used to clean oxides from a surface. JP 8222628 and U.S. Pat. No.3,979,241 use an etching solution of ammonium fluoride and ethylene glycol to remove insulating coatings, and JP 1125831 uses this same blend at a different concentration to remove silicon-based compounds. U.S. Pat. Nos. 6,090,721 and 5,939,336 blends ammonium fluoride, propylene glycol and water to etch metal-containing etch residues from silicon containing substrates. U.S. Pat. No. 5,478,436 uses ammonium fluoride and ethylene glycol to remove metal-based contaminants from a silicon surface. Although many of these solutions can be tailored to be a selective removal chemistry solution; can be effective in low H₂O content or anhydrous environments; and can etch and/or clean effectively at the center of the wafer or surface and at the edge of the wafer or surface, none of these compounds can selectively remove deleterious materials from a surface without substantially etching and/or removing necessary silicon-based compounds and/or metal-based layers and compounds.

U.S. Pat. No. 6,150,282 issued to Rath et al. discloses a method for selectively etching residues which comprises contacting “an article containing said residues and at least one member selected from the group consisting of metal, silicon, silicide and interlevel dielectric materials with a substantially non-aqueous cleaning composition containing” fluoride and an organic solvent. In order to produce a “substantially non-aqueous” solution, Rath either uses 49% by weight aqueous HF and an anhydride chosen to reduce the amount of water in solution (as shown in Col. 2, lines 61-end, Col. 3, lines 1-21 and claim 24) or uses anhydrous HF gas bubbled into an organic solvent. In addition, Rath does not contemplate or disclose utilizing specifically chosen additives, such as chelating agents or chelators, oxidizing agents and/or surfactants, in order to improve the properties of the cleaning composition or to reduce deleterious effects of other components. Finally, Rath does not contemplate utilizing aqueous fluoride-containing solutions when their potentially detrimental aqueous properties can be reduced or eliminated by the addition of compounds which do not act to remove water, but instead act to reduce water's influence on the final solution.

Therefore, it would be desirable to form selective removal chemistry solutions that can do at least one of the following: a) can be tailored to be a selective etching solution and/or a selective cleaning solution; b) can be effective in both aqueous and non-aqueous environments; c) can contain at least one low H₂O content and/or anhydrous component; d) can be anhydrous or have a low H₂O content; e) can contain at least one additive that reduces or eliminates the influence of water on the final solution without necessarily removing water as a component; f) can etch and/or clean effectively at the center of the wafer and at the edge of the wafer and at the same time can selectively etch polymeric compositions from a surface without significantly or meaningfully etching silicon-based compounds or metal-based layers and compounds; and g) can etch and/or clean effectively surfaces, wherein the solutions are selective to any sacrificial layer and/or modified sacrificial layer in order to advance the production of layered materials, electronic components and semiconductor components.

### SUMMARY OF THE SUBJECT MATTER

Removal chemistry solutions and methods of production thereof are described herein that include at least one fluorine-based constituent, at least one chelating component, surfactant component, oxidizing component or combination thereof, and at least one solvent or solvent mixture.

Removal chemistry solutions and methods of production thereof are also described herein that include at least one low H₂O content fluorine-based constituent and at least one solvent or solvent mixture.

### BRIEF DESCRIPTION OF THE FIGURES

Prior Art FIGS. 1A-1C show ash residues in a via clean (FIG. 1A), a trench clean (FIG. 1B) and an etch stop clean (FIG. 1C) application.

Prior Art FIGS. 2A-2C show etch residues in a via clean (FIG. 2A), a trench clean (FIG. 2B) and an etch stop clean (FIG. 2C) application.

Prior Art FIG. 3 shows a layered material that comprises an organic BARC (Bottom Anti-Reflective Coating), wherein the organic BARC needs to be removed without impacting critical dimensions.

FIG. 4 shows a Cox Response trace plot for contemplated co-solvent solutions.

FIG. 5 shows a Cox Response trace plot for contemplated co-solvent solutions.

FIG. 6 shows pre- and post-exposure coupons before and after the application of a contemplated removal chemistry solution.

FIG. 7 shows pre- and post-exposure coupons before and after the application of a contemplated removal chemistry solution.

### DETAILED DESCRIPTION

Removal chemistry solutions and methods of production thereof are described herein that include at least one fluorine-based constituent, at least one chelating component, surfactant component, oxidizing component or combination thereof, and at least one solvent or solvent mixture. Removal chemistry solutions and methods of production thereof are also described herein that include at least one low H₂O content fluorine-based constituent and at least one solvent or solvent mixture.

Contemplated removal chemistry solutions comprise at least one fluorine-based constituent, including at least one aqueous fluorine-based constituent, at least one low H₂O content fluorine-based constituent or a combination thereof. The at least one aqueous fluorine-based constituent is considered to be solutions such as a 49 percent by weight aqueous solution of HF.

The fluorine-based constituent may comprise any suitable fluoride source, such as R₁R₂R₃R₄NF, where R₁, R₂, R₃ and R₄ can be the same or different and can be H or any hydrocarbon moiety of 10 or less carbon units and may be aliphatic, aromatic or cyclic, such as ammonium fluoride, tetramethylammonium fluoride, tetrabutylammonium fluoride, tetraethylammonium fluoride or benzyltrimethylammonium fluoride; hydrogen fluoride, pyridine hydrogen fluoride, ammonium bifluoride or combinations thereof.

As used herein, the phrase “low H₂O content” means that the constituent comprises less than about 10% water by volume. In some embodiments, the at least one low H₂O content fluorine-based constituent comprises less than about 5% water by volume. In other embodiments, the at least one low H₂O content fluorine-based constituent comprises less than about 2.5% water by volume. In yet other embodiments, the at least one low H₂O content fluorine-based constituent comprises less than about 1% water by volume. For some embodiments, the at least one low H₂O content fluorine-based constituent comprises less than about 0.5% water by volume. And in other embodiments, the at least one low H₂O content fluorine-based constituent is anhydrous.

The fluorine-based constituent may be added in any suitable manner, including bubbling a gas comprising the fluorine-based constituent into the at least one solvent or solvent mixture or blending the fluorine-based constituent into the at least one solvent or solvent mixture. In one contemplated embodiment, anhydrous hydrogen fluoride gas is bubbled into desired solvent or mixture of solvents.

The fluorine-based constituents may be present in solution in an amount less than about 70% by weight. In some embodiments, the fluorine-based constituents are present in solution in an amount from about 0.005% to about 70% by weight. In other embodiments, the fluorine-based constituents are present in solution in an amount from about 0.005% to about 45% by weight. In yet other embodiments, the fluorine-based constituents are present in solution in an amount from about 0.005% to about 20% by weight. And in some embodiments, the fluorine-based constituents are present in solution in an amount from about 0.005% to about 5% by weight.

The fluorine-based constituent is added to at least one solvent or solvent mixture. Contemplated solvents include any suitable pure or mixture of organic molecules that are volatilized at a desired temperature, such as the critical temperature, or that can facilitate any of the above-mentioned design goals or needs. The solvent may also comprise any suitable pure or mixture of polar and non-polar compounds. As used herein, the term “pure” means that component that has a constant composition. For example, pure water is composed solely of H₂O. As used herein, the term “mixture” means that component that is not pure, including salt water. As used herein, the term “polar” means that characteristic of a molecule or compound that creates an unequal charge, partial charge or spontaneous charge distribution at one point of or along the molecule or compound. As used herein, the term “non-polar” means that characteristic of a molecule or compound that creates an equal charge, partial charge or spontaneous charge distribution at one point of or along the molecule or compound. One of ordinary skill in the art of chemistry and etching solutions will know which solvents are non-polar and which solvents are clearly polar in nature.

The solvent or solvent mixture (comprising at least two solvents) may comprises those solvents that are considered part of the hydrocarbon family of solvents. Hydrocarbon solvents are those solvents that comprise carbon and hydrogen. It should be understood that a majority of hydrocarbon solvents are non-polar; however, there are a few hydrocarbon solvents that could be considered polar. Hydrocarbon solvents are generally broken down into three classes: aliphatic, cyclic and aromatic. Aliphatic hydrocarbon solvents may comprise both straight-chain compounds and compounds that are branched and possibly crosslinked, however, aliphatic hydrocarbon solvents are not considered cyclic. Cyclic hydrocarbon solvents are those solvents that comprise at least three carbon atoms oriented in a ring structure with properties similar to aliphatic hydrocarbon solvents. Aromatic hydrocarbon solvents are those solvents that comprise generally three or more unsaturated bonds with a single ring or multiple rings attached by a common bond and/or multiple rings fused together. Contemplated hydrocarbon solvents include toluene, xylene, p-xylene, m-xylene, mesitylene, solvent naphtha H, solvent naphtha A, alkanes, such as pentane, hexane, isohexane, heptane, nonane, octane, dodecane, 2-methylbutane, hexadecane, tridecane, pentadecane, cyclopentane, 2,2,4-trimethylpentane, petroleum ethers, halogenated hydrocarbons, such as chlorinated hydrocarbons, nitrated hydrocarbons, benzene, 1,2-dimethylbenzene, 1,2,4-trimethylbenzene, mineral spirits, kerosine, isobutylbenzene, methylnaphthalene, ethyltoluene, ligroine. Particularly contemplated solvents include, but are not limited to, pentane, hexane, heptane, cyclohexane, benzene, toluene, xylene and mixtures or combinations thereof.

The solvent or solvent mixture may comprise those solvents that are not considered part of the hydrocarbon solvent family of compounds, such as ketones, such as acetone, diethyl ketone, methyl ethyl ketone and the like, alcohols, esters, ethers and amines. Other contemplated solvents include propylene carbonate, butylene carbonate, ethylene carbonate, gamma-butyrolactone, propylene glycol, ethyl lactate, propylene glycol monomethyl ether acetate or a combination thereof. In yet other contemplated embodiments, the solvent or solvent mixture may comprise a combination of any of the solvents mentioned herein.

The at least one solvent or solvent mixture may be those solvents that contain nitrogen atoms, phosphorus atoms, sulfur atoms or a combination thereof, such as N-methyl-2-pyrrolidone, N,N-dimethylacetamide, dimethyl sulfoxide, pyridine or a combination thereof. Both the etching and the cleaning solutions contemplated herein also utilize a compatible solvent constituent.

Solvents and solvent mixtures may be present in solution in an amount less than about 99.5% by weight. In some embodiments, the solvents or solvent mixtures may be present in solution in an amount from about 30% to about 99.5% by weight.

The solvents used herein may comprise any suitable impurity level, such as less than about 1 ppm, less than about 100 ppb, less than about 10 ppb, less than about 1 ppb, less than about 100 ppt, less than about 10 ppt and in some cases, less than about 1 ppt. These solvents may be purchased having impurity levels that are appropriate for use in these contemplated applications or may need to be further purified to remove additional impurities and to reach the less than about 10 ppb, less than about 1 ppb, less than about 100 ppt or lower levels that are becoming more desirable in the art of etching and cleaning.

As mentioned, contemplated methods for producing removal chemistry solutions include providing at least one gaseous low H₂O content fluorine-based constituent, providing at least one solvent or solvent mixture, and bubbling the at least one low H₂O content fluorine-based constituent into the at least one solvent or solvent mixture to form the removal chemistry solution. Other contemplated methods include providing at least one low H₂O content fluorine-based constituent, providing at least one solvent or solvent mixture, and blending the at least one low H₂O content fluorine-based constituent into the at least one solvent or solvent mixture to form the removal chemistry solution.

Additional components may be added to the at least one solvent or solvent mixture, the at least one fluorine-based constituent and/or the removal chemistry solutions produced initially. For example, it may be desirable to dissolve into the solvent constituents components that are nitrogen-containing species, including chelators or NH₃. Some of these components are solids at ambient conditions such as amine chelators (e.g. hexamethylenetetramine, EDTA), and when utilizing these components, unique amine-HF adducts may be formed during the anhydrous hydrogen fluoride gas addition. Water may also be an additional component that is desirable in contemplated solutions.

Chelating agents, such as an organic acid (acetic acid, citric acid, lactic acid, oxalic acid, tartaric acid, gluconic acid, iminodiacetic acid, succinic acid, malic acid, maleic acid or a combination thereof.), an amine (hexamethylenetetramine, triethanolamine, nitrilotriacetic acid, tris(2-pyridylmethyl)amine, EDTA), phosphonates, such as diamyl amylphosphonate, bis(2-chloroethyl) methyl phosphonate, dibutyl butylphosphonate, diethyl benzylphosphonate, nitrilotris(methylene)triphosphonic acid, hydroxyethylidenediphosphonic acid, sulfonic acid, such as 3-(N-tris[hydroxymethyl]methylamine)-2-hydroxypropanesulfonic acid, 3([1,1-dimethyl-2-hydroxyethyl)amine]-2-hydroxypropanesulfonic acid, 1,2,4,5-benzenetetracarboxylic acid, THF-tetracarboxylic acid, trifluoroacetic acid, N-(2-(acetamido)imino)diacetic acid, H₃PO₄ or combinations thereof of any of the above chelating agents may also be added to the at least one solvent or solvent mixture, the at least one fluorine-based constituent and/or the removal chemistry solutions produced initially The chelator may be dissolved directly into the first solvent or solvent mixture pre or post fluorine-based constituent (such as HF_{(g)}) addition, or if the chelator has low solubility in the first solvent or solvent mixture, can first be dissolved in an appropriate co-solvent prior to addition to first solvent or solvent mixture. In some embodiments, chelating agents comprise metal chelating agents. As contemplated herein, the at least one chelating agent may be present in solution in an amount less than about 20% by weight. In some embodiments, the at least one chelating agent may be present in solution in an amount from about 0.001% to about 20% by weight. In some embodiments, at least two chelating agents may be present in solution.

Oxidizing agents, such as hydrogen peroxide (aq), ozone (bubbled), urea hydrogen peroxide, benzoyl peroxide, peroxyacetic acid (and halogenated peroxyacetic acids), peroxybenzoic acid, and other organic peroxides may also be added to the at least one solvent or solvent mixture, the at least one fluorine-based constituent and/or the removal chemistry solutions produced initially. The oxidizing agent may be dissolved directly into the first solvent or solvent mixture pre or post fluorine-based constituent (such as HF_{(g)}) addition, or if the oxidizing agent has low solubility in the first solvent or solvent mixture, can first be dissolved in an appropriate co-solvent prior to addition to first solvent or solvent mixture. It is contemplated that some of the oxidizing agents may be anhydrous. As contemplated herein, the at least one oxidizing agent may be present in solution in an amount less than about 20% by weight. In some embodiments, the at least one oxidizing agent may be present in solution in an amount from about 0.001% to about 20% by weight. In some embodiments, at least two oxidizing agents may be present in solution.

A surfactant may be added to the at least one solvent or solvent mixture, the at least one fluorine-based constituent and/or the removal chemistry solutions produced initially to lower surface tension. As used herein, the term “surfactant” means any compound that reduces the surface tension when dissolved in H₂O or other liquids, or which reduces interfacial tension between two liquids, or between a liquid and a solid. Contemplated surfactants may include at least one anionic surfactant, cationic surfactant, non-ionic surfactant, Zwitterionic surfactant or a combination thereof. The surfactant may be dissolved directly into the first solvent or solvent mixture pre or post fluorine-based constituent (such as HF_{(g)}) addition, or if the surfactant has low solubility in the first solvent or solvent mixture, can first be dissolved in an appropriate co-solvent prior to addition to first solvent or solvent mixture. Contemplated surfactants may include: sulfonates such as dodecylbenzene sulfonate, tetrapropylenebenzene sulfonate, dodecylbenzene sulfonate, a fluorinated anionic surfactant such as Fluorad FC-93, and L-18691 (3M), fluorinated nonionic surfactants such as FC-4430 (3M), FC-4432 (3M), and L-18242 (3M), quaternary amines, such as dodecyltrimethylammonium bromide or cetyltrimethylammonium bromide, alkyl phenoxy polyethylene oxide alcohols, alkyl phenoxy polyglycidols, acetylinic alcohols, polyglycol ethers such as Tergitol TMN -6 (Dow) and Tergitol minifoam 2x (Dow), polyoxyethylene fatty ethers such as Brij-30 (Aldrich), Brij-35 (Aldrich), Brij-58 (Aldrich), Brij-72 (Aldrich), Brij-76 (Aldrich), Brij-78 (Aldrich), Brij-98 (Aldrich), and Brij-700 (Aldrich), betaines, sulfobetaines, such as cocoamidopropyl betaine, and synthetic phospholipids, such as dioctanoylphosphatidylcholine and lecithin and combinations thereof. As contemplated herein, the at least one surfactant may be present in solution in an amount less than about 5% by weight. In some embodiments, the at least one surfactant may be present in solution in an amount from about 0.001% to about 5% by weight. In some embodiments, at least two surfactant constituents may be present in solution.

In yet other embodiments, the removal chemistry solution may comprise at least two chelating agents/constituents, oxidizing agents/constituents, surfactants or a combination thereof. In some of these embodiments, the removal chemistry may comprise a chelating agent and an oxidizing agent or a chelating agent and a surfactant or an oxidizing agent and a surfactant. In other embodiments, the removal chemistry may comprise at least two chelating agents, at least two chelating agents and an oxidizing agent and/or surfactant, for example. These examples should provide information to one of ordinary skill in the art that one or more of these additives can be incorporated into the removal chemistry solution alone or in combination.

In addition, it should be understood that the presence of the at least one chelating agent, surfactant, oxidizing agent or combination thereof can minimize any deleterious effects of water in the removal chemistry solution. Therefore, in some embodiments where a low H₂O content fluorine-based constituent is added to a solvent or solvent mixture, it is necessary for a low H₂O content to exist in solution. However, once strategic additives are incorporated into the removal chemistry solution, it is no longer necessary to carefully monitor the water content of the solution. This discovery was first reported in PCT Application Serial No. PCT/US04/38761 in the Examples section, which is incorporated herein in its entirety by reference.

Components that can provide an additional fluoride source, such as ammonium fluoride, hydrogen fluoride, tetramethylammonium fluoride, tetrabutylammonium fluoride, tetraethylammonium fluoride, benzyltrimethylammonium fluoride, pyridine hydrogen fluoride, ammonium bifluoride or combinations thereof may also be added to the at least one solvent or solvent mixture, the at least one fluorine-based constituent and/or the removal chemistry solutions produced initially. The additional fluoride source may be dissolved directly into the first solvent or the solvent mixture pre or post fluorine-based constituent (such as HF(g)) addition, or if the additional fluoride source has low solubility in the first solvent or the solvent mixture, can first be dissolved in an appropriate co-solvent prior to addition to the first solvent or the solvent mixture. As contemplated herein, the at least one fluoride source may be present in solution in an amount less than about 20% by weight. In some embodiments, the at least one fluoride source may be present in solution in an amount from about 0.001% to about 20% by weight.

The at least one fluorine-based constituent, the at least one solvent or solvent mixture and/or any other constituent/additive mentioned herein may be provided by any suitable method, including a) buying at least some of at least one fluorine-based constituent, the at least one solvent or solvent mixture and/or any other constituent/additive mentioned herein from a supplier; b) preparing or producing at least some of the at least one fluorine-based constituent, the at least one solvent or solvent mixture and/or any other constituent/additive mentioned herein in house using chemicals provided by another source and/or c) preparing or producing at least some of the at least one fluorine-based constituent, the at least one solvent or solvent mixture and/or any other constituent/additive mentioned herein in house using chemicals also produced or provided in house or at the location.

Once the constituents are provided, the at least one fluorine-based constituent is added to the at least one solvent or solvent mixture to form the removal chemistry solution. In one contemplated embodiment, HF_{(g)} is bubbled into the at least one solvent or solvent mixture until desired weight percent (wt %) concentration is reached, which may include the saturation point of HF_{(g)} in the solvent(s). Alternately, hydrogen fluoride gas can be gassed into a first solvent, and then another solvent or solvent mixture may be dissolved into the first solvent post HF_{(g)} addition.

As mentioned, once the at least one fluorine-based constituent and the at least one solvent or solvent mixture constituent are provided, they are blended to form a solution, wherein the solution constituents are at a suitable concentration to etch and/or clean sacrificial layers, modified sacrificial layers and/or patterns of both of these compositions from a surface without significantly reacting with any adjacent and/or corresponding layers, such as dielectric layers, hard mask layers, metal layers, etc. The removal chemistry solutions contemplated herein can be custom blended for specific applications; however, it is contemplated that the process of custom blending does not require undue experimentation once the disclosure herein, including the stated goals, is understood by one of ordinary skill in the art of etching solutions for electronic and semiconductor applications.

Methods of forming and uses of these removal chemistries are also contemplated and described herein. Such methods include providing the constituents of the removal chemistry formulation, blending the constituents to form the formulation and applying the formulation to a surface or substrate. In some embodiments, the formulation may be produced in situ (directly on the surface) or may be formed before application to the surface. Specifically, methods are described herein for producing a removal chemistry solution that include at least one gaseous low H₂O content fluorine-based constituent, providing at least one solvent or solvent mixture, and bubbling the at least one low H₂O content fluorine-based constituent into the at least one solvent or solvent mixture to form the removal chemistry solution.

Methods may also include producing removal chemistry solutions that include providing at least one fluorine-based constituent, providing at least one chelating component, surfactant component, oxidizing component or combination thereof, providing at least one solvent or solvent mixture, and combining the at least one fluorine-based constituent and the at least one fluorine-based constituent, providing at least one chelating component, surfactant component, oxidizing component or combination thereof with the at least one solvent or solvent mixture to form the removal chemistry solution.

The removal chemistry solution may be applied to a semiconductor wafer post photoresist deposition (may be pre or post lithography) for wafer rework purposes, or after etch/plasma treatment (for post etch/post ash residue removal) in either a single wafer or batch processing tool for a period of time between about 15 seconds and about 90 minutes. Processing temperature may be from about 20° C. up to about 80° C. The wafer may be dipped into solution once and held for a particular time period or dipped multiple times, may be rinsed by the solution, may have the solution applied in a methodical patterned form, may be masked and then rinsed by the solution, etc.

The removal chemistry solution may also be held at a particular temperature which optimizes the removal abilities of the solution or may be varied with respect to temperature depending on the wafer or surface. The term “varied” is used herein with respect to temperature to mean that the solution temperature may be varied while the wafer is being processed or may be varied from wafer to wafer depending on the extent of residue that needs to be removed. In some contemplated embodiments, the temperature of the removal chemistry solution is held at less than about 80° C. In other contemplated embodiments, the temperature of the removal chemistry solution is held at less than about 50° C. In yet other contemplated embodiments, the temperature of the removal chemistry solution is held at about 30° C.

In a single wafer tool, removal chemistry solutions may also be applied as a puddle on a stationary wafer which is then rotated at a set speed. Alternately, the removal chemistry solution may be applied as a spray to a wafer that is rotating, either with dispensing occurring at the center of the wafer only, or having a dispense head that moves from the center position to the edge of the wafer, or having multiple fixed dispense heads that are spaced evenly from center to edge of wafer. For batch processing wafers are immersed in a tank of removal chemistry solution, and turbulence is created with agitation, ultrasonics/megasonics and/or air bubbling.

Samples may be pretreated before application of removal chemistry solution. Pretreatment can include applying a liquid or vapor to the wafer surface to improve wetting when the removal chemistry solution is applied. Also pretreatment may include application of liquid or vapor to the wafer surface to chemically modify the surface to increase effectiveness/improve selectivity of removal chemistry solution.

Wafers and layered materials contemplated herein comprise those wafers and layered materials that are utilized or considered to be utilized in semiconductor or electronic applications, such as dual damascene structures, and comprise at least one layer of material. Surfaces contemplated herein may comprise any desirable substantially solid material, such as a substrate, wafer or other suitable surface. Particularly desirable substrate layers would comprise films, organic polymer, inorganic polymer, glass, ceramic, plastic, metal or coated metal, or composite material. Surface and/or substrate layers comprise at least one layer and in some instances comprise a plurality of layers. In other embodiments, the substrate comprises a material common in the integrated circuit industries as well as the packaging and circuit board industries such as silicon, copper, glass, and another polymer. Suitable surfaces contemplated herein may also include another previously formed layered stack, other layered component, or other component altogether. An example of this may be where a dielectric material and CVD barrier layer are first laid down as a layered stack—which is considered the “surface” for the subsequently spun-on layered component.

Removal chemistries described herein can exhibit greater than about a 100:1 removal rate of copper oxide to copper. In some embodiments, the removal rate may be greater than about 500:1 of copper oxide to copper. And in yet other embodiments, the removal rate may be greater than about 1000:1 of copper oxide to copper. In addition, removal chemistry solutions described herein can substantially completely remove a copper oxide layer from a substrate or layered material. As used herein, “substantially completely remove” means that a layer or material may be removed such that it is a) no longer physically visible, b) no longer deleterious to the component, layer or surface, c) no longer visible using generally accepted microscopic techniques or a combination thereof.

Therefore, as described herein and as shown by the following examples, selective removal chemistry solutions have been developed that can do at least one of the following: a) can be tailored to be a selective etching solution and/or a selective cleaning solution; b) can be effective in both aqueous and non-aqueous environments; c) can contain at least one low H₂O content and/or anhydrous component; d) can be anhydrous or have a low H₂O content; e) can contain at least one additive that reduces or eliminates the influence of water on the final solution without necessarily removing water as a component; f) can etch and/or clean effectively at the center of the wafer and at the edge of the wafer and at the same time can selectively etch polymeric compositions from a surface without significantly or meaningfully etching silicon-based compounds or metal-based layers and compounds; and g) can etch and/or clean effectively surfaces, wherein the solutions are selective to any sacrificial layer and/or modified sacrificial layer in order to advance the production of layered materials, electronic components and semiconductor components.

### EXAMPLES

### Example 1

In this example, various combinations of anhydrous (anh.) hydrogen fluoride, propylene carbonate (PC) and acetic acid (HOAc) were prepared in order to test etch rates for blanket films of materials common to semiconductor/memory devices applications.

To make the formulations, 30% by weight anh. HF in acetic acid was used as the source of anhydrous HF. Solutions of 10% anh. HF by weight in acetic acid, 5% anh. HF by weight in acetic acid, 2.5% anh. HF by weight in acetic acid and 1.25% by weight anh. HF in acetic acid were prepared in tared 500 mL HDPE bottles, with component amounts as follows:

| SOLUTION PREPARED | WEIGHT OF | |
|---|---|---|
| (WT. PREPARED) | COMPONENTS (G) | COMPONENT (DESCRIPTION) |
| 10% anh. HF by | 200 | 30% by weight anh. HF in acetic acid |
| weight | 400 | acetic acid |
| (600 g) | | |
| 5% anh. HF by weight | 200 | 10% anh. HF by weight in acetic acid |
| (400 g) | 200 | acetic acid |
| 2.5% anh. HF by | 200 | 5% anh. HF by weight in acetic acid |
| weight | 200 | acetic acid |
| (400 g) | | |
| 1.25% anh. HF by | 200 | 2.5% anh. HF by weight in acetic acid |
| weight | 200 | acetic acid |
| (400 g) | | |

The resulting anh. HF/acetic acid stock solutions were then used to prepare propylene carbonate/anh. HF/acetic acid solutions. The component amounts were as follows:

| SOLUTION PREPARED | WEIGHT OF | |
|---|---|---|
| (WT. PREPARED) | COMPONENTS (G) | COMPONENT (DESCRIPTION) |
| ˜0.25% anh. HF by weight in 3.5:1 PC:HOAc | 332.5 | propylene carbonate |
| (418.5 g) | 86 | 1.25% anh. HF by weight in HOAc |
| ˜0.5% anh. HF by weight in 3.5:1 PC:HOAc | 332.5 | propylene carbonate |
| (418.5 g) | 86 | 2.5% anh. HF by weight in HOAc |
| ˜1% anh. HF by weight in 3.5:1 PC:HOAc | 332.5 | propylene carbonate |
| (418.5 g) | 86 | 5% anh. HF by weight in HOAc |
| ˜2% anh. HF by weight in 3.5:1 PC:HOAc | 332.5 | propylene carbonate |
| (418.5 g) | 86 | 10% anh. HF by weight in HOAc |
| 1% anh. HF by weight in 9:1 PC:HOAc | 108 | propylene carbonate |
| (118.45 g) | 10.45 | 10% anh. HF by weight in HOAc |
| 1% anh. HF by weight in 30:1 PC:HOAc | 116.4 | propylene carbonate |
| (119.535 g) | 3.135 | 30% anh. HF by weight in HOAc |

The following solutions were also produced to use as a comparison:

| SOLUTION PREPARED | WEIGHT OF | |
|---|---|---|
| (WT. PREPARED) | COMPONENTS (G) | COMPONENT (DESCRIPTION) |
| 1% anh. HF by weight in acetic acid | 94.05 | acetic acid |
| (104.5 g) | 10.45 | 10% anh. HF by weight in HOAc |
| 1% HF (aq) by weight | 96 | Deionized (DI) H₂O |
| (98.3 g) | 2.3 | 49% HF by weight |
| 1% HF (aq) by weight in 3.5:1 PC:HOAc | 83 | propylene carbonate |
| (106.1 g) | 21 | acetic acid |
| | 2.1 | 49% HF by weight |

Etch Procedure:

Approximately 2 cm×2 cm films of the following materials: thermal oxide (TOx), TEOS (tetraethoxysilane, which is, in this example, applied by vapor deposition) and CVD OSG (k ˜2.7) had a film thickness measured by reflectometer. Samples were then clamped and placed into solution that was held at 21.5° C. by use of a temperature bath. Reaction was allowed to take place for a period of 10 minutes. Samples were then removed from solution and placed into a beaker of water to quench the reaction. Wafer samples were thoroughly dried with CDA and a post treatment film measurement was taken using the reflectometer.

These materials, such as thermal oxide, TEOS and CVD OSG, are generally applied by vapor deposition and are similar to or the same as those compounds manufactured by Honeywell International Inc. These materials can also be provided by other companies. For example, the TEOS-based films and HSQ films may be manufactured in-house at Honeywell International, Inc or provided by other companies. Thermal oxide and OSG films may be provided by customers or other vendors, such as Novellus (CORAL™) or Applied Materials (BLACK DIAMOND™). In some embodiments, for example, TEOS films may comprise a thickness of around 1000 Å, TOx films may comprise a thickness of about 9000 Å and OSG films may comprise a thickness of about 4000 Å.

These materials that may be used on wafers and layered materials comprise inorganic-based compounds, such as silicon-based compounds. Examples of silicon-based compounds comprise siloxane compounds, such as methylsiloxane, methylsilsesquioxane, phenylsiloxane, phenylsilsesquioxane, methylphenylsiloxane, methylphenylsilsesquioxane, silazane polymers, silicate polymers and mixtures thereof. Examples of siloxane polymers and blockpolymers include hydrogensiloxane polymers of the general formula (H_{0-1.0}SiO_{1.5-2.0})ₓ and hydrogensilsesquioxane polymers, which have the formula (HSiO_{1.5})ₓ, where x is greater than about four. Also included are copolymers of hydrogensilsesquioxane and an alkoxyhydridosiloxane or hydroxyhydridosiloxane. Several of the contemplated vapor deposition and spin-on materials are described in the following issued patents and pending applications, which are herein incorporated by reference in their entirety: (PCT/US00/15772 filed Jun. 8, 2000; U.S. application Ser. No. 09/330248 filed Jun. 10, 1999; U.S. application Ser. No. 09/491166 filed Jun. 10, 1999; U.S. Pat. No. 6,365,765 issued on Apr. 2, 2002; U.S. Pat. No. 6,268,457 issued on Jul. 31, 2001; U.S. application Ser. No. 10/001143 filed Nov. 10, 2001; U.S. application Ser. No. 09/491166 filed Jan. 26, 2000; PCT/US00/00523 filed Jan. 7, 1999; U.S. Pat. No. 6,177,199 issued Jan. 23, 2001; U.S. Pat. No. 6,358,559 issued Mar. 19, 2002; U.S. Pat. No. 6,218,020 issued Apr. 17, 2001; U.S. Pat. No. 6,361,820 issued Mar. 26, 2002; U.S. Pat. No. 6,218,497 issued Apr. 17, 2001; U.S. Pat. No. 6,359,099 issued Mar. 19, 2002; U.S. Pat. No. 6,143,855 issued Nov. 7, 2000; and U.S. application Ser. No. 09/611528 filed Mar. 20, 1998).

TEOS, for example, can also be a component of or incorporated into contemplated sacrificial anti-reflective and absorbing coating materials for ultraviolet photolithography, such as those disclosed in PCT Applications PCT/US02/36327 filed on Nov. 12, 2002; PCT/US03/36354 filed on Nov. 12, 2003 and in U.S. application Ser. No. 10/717028 filed on Nov. 18, 2003. These sacrificial materials are also disclosed in U.S. Pat. Nos. 6268457, 6365765, and U.S. Ser. Nos. 10/076846, 10/300357 and 11/178544, which are all commonly-owned and incorporated herein in their entirety. These types of sacrificial materials may be removed by the removal chemistries disclosed herein.

The results of the experiments utilizing these solutions are as follows:

| | | Pre-thickness | | Post-thickness | | Etch Time | | Etch Rate |
|---|---|---|---|---|---|---|---|---|
| Solution | Material | (Å) | | (Å) | | (min) | T (° C.) | (Å/min) |
| 0.25% anh. HF by | TOx | 9981 | 9967 | 9954 | 9967 | 10 | 22 | 2.35 |
| weight in 3.5:1, by | TEOS | 1021 | 1024 | 1015 | 1023 | 10 | 22 | 0.35 |
| volume, PC:HOAc | OSG | 4204 | 4196 | 4206 | 4000 | 10 | 22 | −0.3 |
| 0.5% anh. HF by | TOx | 9964 | 9965 | 9949 | 9955 | 10 | 21.5 | 1.25 |
| weight in 3.5:1, by | TEOS | 1013 | 1015 | 992.2 | 989.2 | 10 | 21.5 | 2.33 |
| volume, PC:HOAc | OSG | 4185 | 4180 | 4180 | 4186 | 10 | 21.5 | −0.05 |
| 1% anh. HF by | TOx | 9973 | 9981 | 9953 | 9945 | 10 | 21.5 | 2.8 |
| weight in 3.5:1, by | TEOS | 1043 | 1045 | 991.6 | 993.3 | 10 | 21.5 | 5.16 |
| volume, PC:HOAc | OSG | 4148 | 4146 | 4145 | 4140 | 10 | 21.5 | 0.45 |
| 2% anh. HF by | TOx | 9941 | 9934 | 9911 | 9908 | 10 | 21.5 | 5.6 |
| weight in 3.5:1, by | TEOS | 1026 | 1024 | 978.3 | 980.9 | 10 | 21.5 | 9.08 |
| volume, PC:HOAc | OSG | 4216 | 4223 | 4228 | 4229 | 10 | 21.5 | −1.8 |
| 1% anh. HF by | TOx | 9918 | 9919 | 9844 | 9842 | 10 | 21.5 | 7.55 |
| weight in HOAc | TEOS | 1046 | 1045 | 913.7 | 922.3 | 10 | 21.5 | 12.75 |
| | OSG | 4153 | 4153 | 4150 | 4142 | 10 | 21.5 | 0.7 |
| 1% HF (aq) by | TOx | 9944 | 9944 | 9427 | 9433 | 10 | 21.5 | 51.4 |
| weight | TEOS | 1019 | 1016 | 0 | 0 | 10 | 21.5 | >101.75 |
| | OSG | 4169 | 4169 | 3920 | 3924* | 10 | 21.5 | 24.7 |
| 1% HF(aq) in | TOx | | 9985 | | 9945 | 10 | 21.5 | 4 |
| 3.5:1, by volume, | TEOS | | 1004 | | 924 | 10 | 21.5 | 8 |
| PC:HOAc | OSG | | 4175 | | 4181 | 10 | 21.5 | −0.6 |
| 1% anh. HF by | TOx | 9999 | 9998 | 9992 | 9998 | 10 | 21.5 | 0.35 |
| weight in 9:1, by | TEOS | 1024 | 1048 | 1010 | 1011 | 10 | 21.5 | 0.9 |
| volume, PC:HOAc | OSG | 4113 | 4104 | 4224 | 4225 | 10 | 21.5 | −11.6 |
| 0.25% anh. HF by | TOx | 9961 | 9955 | 9943 | 9950 | 10 | 21.5 | 1.15 |
| weight in 30:1, by | TEOS | 1044 | 1048 | 1025 | 1025 | 10 | 21.5 | 2.1 |
| volume, PC:HOAc | OSG | 4089 | 4086 | 4212 | 4225 | 10 | 21.5 | −13.1 |

*OSG film was delaminating

From the data, it is observed that formulations made with anhydrous HF, or those that contain aqueous HF in propylene carbonate and acetic acid have significantly lower dielectric film etch rates compared to aqueous HF. Also, formulations containing lower concentrations of acetic acid had lower film etch rates.

### Example 2

In this example, etch rates of dielectric films exposed to anhydrous mixtures of propylene carbonate and hydrogen fluoride pyridine, mixtures of N-methyl-2-pyrrolidone (NMP)/acetic acid/anh. HF, ethyl lactate (EL)/acetic acid/anh. HF were determined and described below.

Solutions were weighed into tarred 250 mL beakers and mixed. The component amounts were as follows:

| SOLUTION PREPARED | WEIGHT OF | |
|---|---|---|
| (WT. PREPARED) | COMPONENTS (G) | COMPONENT (DESCRIPTION) |
| 1% anh. HF by weight in PC/Pyr | 102 | propylene carbonate |
| (104.6 g) | 2.6 | 3:1 molar ratio HF:pyridine (40% anh. HF by weight) |
| 1% anh. HF by weight in 3.5:1 EL:HOAc | 71.9 | ethyl lactate |
| (93.4 g) | 21.5 | 5% anh. HF by weight in HOAc |
| 1% anh. HF by weight in 3.5:1 NMP:HOAc | 71.2 | N-methyl-2-pyrrolidone |
| (92.7 g) | 21.5 | 5% anh. HF by weight in HOAc |

Etch Procedure:

Approximately 2 cm×2 cm films of the following materials: thermal oxide (TOx), TEOS and CVD OSG (k ˜2.7) had a film thickness measured by reflectometer. Samples were then clamped and placed into solution that was held at 21.5° C. by use of a temperature bath. Reaction was allowed to take place for a period of 10 minutes. Samples were then removed from solution and placed into a beaker of water to quench the reaction. Wafer samples were thoroughly dried with CDA and a post treatment film measurement was taken using the reflectometer.

The results of experiments utilizing these solutions are as follows:

| | | Pre- | | Post- | | Etch Time | | Etch Rate |
|---|---|---|---|---|---|---|---|---|
| Solution | Material | thickness (Å) | | thickness (Å) | | (min) | T (° C.) | (Å/min) |
| 1% anh. HF by | TOx | | 9983 | | 8056 | 10 | 21.5 | 192.7 |
| weight in PC:Pyr | TEOS | | 1012 | | 0 | 10 | 21.5 | >101.2 |
| | OSG | | 4229 | | 0 | 10 | 21.5 | >422.9 |
| 1% anh. HF by | TOx | 9979 | 9984 | 9964 | 9963 | 10 | 21.5 | 1.8 |
| weight in 3.5:1, by | TEOS | 1042 | 1049 | 1030 | 1025 | 10 | 21.5 | 1.8 |
| volume, EL:HOAc | OSG | 4183 | 4187 | 4183 | 4182 | 10 | 21.5 | 0.25 |
| 1% anh. HF by | TOx | 9978 | 9983 | 9977 | 9975 | 10 | 21.5 | 0.45 |
| weight in 3.5:1, by | TEOS | 1023 | 1029 | 1019 | 1017 | 10 | 21.5 | 0.8 |
| volume, | OSG | 4167 | 4159 | 4197 | 4192 | 10 | 21.5 | −3.15 |
| NMP:HOAc | | | | | | | | |

From the data it is observed that using pyridine:HF as the anhydrous HF source results in significantly higher etch rates. It is also observed that using N-methyl-2-pyrrolidone or ethyl lactate as the solvent has little impact on the film etch rate.

### Example 3

In this example, etch rates of SiN and Cu, and time of removal of copper oxide by anhydrous PC/HF/HOAc mixtures were determined and are described below.

Solutions of about 0.25% by weight, about 0.5% by weight, about 1% by weight and about 2% by weight anh. HF in 3.5:1 PC:HOAc solutions were prepared as described in Example 1. Copper oxide films were formed by oxidizing 2 cm×2 cm Cu blanket films on a hot plate at a heat setting of about 6. Copper oxide samples were immersed in anh. HF/PC/HOAc solutions in a temperature controlled bath, checking samples every 30 seconds until the film is visibly removed. Etch rates of SiN and Cu were performed as described earlier.

The results of experiments utilizing these solutions are as follows:

| | | Pre-thickness | | Post-thickness | | Etch Time | | Etch Rate |
|---|---|---|---|---|---|---|---|---|
| Solution | Material | (Å) | | (Å) | | (min) | T (° C.) | (Å/min) |
| 0.25% anh. HF by | SiN | 325.4 | 328.0 | 284.7 | 281.5 | 10 | 22 | 4.36 |
| weight in 3.5:1, by | Cu | 1248 | 1244 | 1026 | 987 | 10 | 22 | 23.95 |
| volume, PC/HOAc | | | | | | | | |
| 0.5% anh. HF by | SiN | 326.4 | 310.1 | 264.7 | 259.2 | 10 | 22 | 5.63 |
| weight in 3.5:1, by | Cu | 1254 | 1254 | 1032 | 1032 | 10 | 22 | 22.2 |
| volume, PC/HOAc | | | | | | | | |
| 2% anh. HF by | SiN | 269.9 | 306.2 | 245.0 | 262.4 | 10 | 22 | 9.57 |
| weight in 3.5:1, by | Cu | 1087 | 1032 | 938.6 | 0938.6 | 10 | 22 | 12.09 |
| volume, PC/HOAc | | | | | | | | |

| | TIME FOR |
|---|---|
| | VISIBLE COPPER |
| SOLUTION | OXIDEₓ REMOVAL |
| 0.25% anh. HF by weight in 3.5:1, | 4.5 minutes |
| by volume, PC/HOAc | |
| 0.5% anh. HF by weight in 3.5:1, | 4 minutes |
| by volume, PC/HOAc | |
| 2% anh. HF by weight in 3.5:1, | 3.5 minutes |
| by volume, PC/HOAc | |

From the results it can be seen that the formulations have a reasonable copper oxide removal time and SiN etch rate, although the Cu etch rate is higher than desired.

### Example 4

Etch rates of anhydrous propylene carbonate-hydrogen fluoride mixtures of various semiconductor materials were determined and are described below. Materials tested include TEOS, thermal oxide (TOₓ), OSG (k=about 2.7), Si₃N₄ and HSQ (a sacrificial dielectric).

An anhydrous propylene carbonate-hydrogen fluoride (PC-HF) solution with a weight percent HF of 5.11 was used as a stock solution to provide concentrations tested. Diluted PC-HF solutions were prepared as follows:

| SOLUTION PREPARED | WEIGHT OF | |
|---|---|---|
| (WT. PREPARED) | COMPONENTS (G) | COMPONENT (DESCRIPTION) |
| 0.25% anh. HF by weight in PC | 25 | propylene carbonate/hydrogen fluoride stock |
| (500 g) | 475 | propylene carbonate |
| 0.5% anh. HF by weight in PC | 50 | propylene carbonate/hydrogen fluoride stock |
| (500 g) | 450 | propylene carbonate |
| 1% anh. HF by weight in PC | 100 | propylene carbonate/hydrogen fluoride stock |
| (500 g) | 400 | propylene carbonate |
| 2% anh. HF by weight in PC | 200 | propylene carbonate/hydrogen fluoride stock |
| (500 g) | 300 | propylene carbonate |

2 cm×2 cm coupons/wafers of TEOS, OSG, HSQ, thermal oxide (TO,) and Si₃N₄ had film thicknesses pre-measured using Filmetrics F20 thin-film measurement system (reflectometer). Sample coupons were soaked in each solution including stock solution for 10 minutes. Samples were then rinsed with DI water and dried with CDA. Sample coupons were then remeasured for film thickness using Filmetrics F20 reflectometer.

The results of experiments utilizing these solutions are as follows:

| | | Pre-thickness | | Post-thickness | | Etch Time | | Etch Rate |
|---|---|---|---|---|---|---|---|---|
| Solution | Material | (Å) | | (Å) | | (min) | T (° C.) | (Å/min) |
| 0.25% by weight | TEOS | 1011 | 1011 | 1008 | 1009 | 10 | 22 | 0.25 |
| anh. HF in PC | OSG | 4227 | 4234 | 4230 | 4240 | 10 | 22 | −0.45 |
| | HSQ | 3246 | 3239 | 2913 | 2912 | 10 | 22 | 32.5 |
| | Si₃N₄ | 268.6 | 301.7 | 287.8 | 279.2 | 10 | 22 | 0.165 |
| | TOₓ | 10020 | 10010 | 10000 | 10000 | 10 | 22 | 1.5 |
| 0.5% by weight anh. | TEOS | 1016 | 1025 | 1014 | 1024 | 10 | 22 | 0.15 |
| HF in PC | OSG | 4231 | 4222 | 4242 | 4229 | 10 | 22 | −0.9 |
| | HSQ | 3254 | 3257 | 2920 | 2915 | 10 | 22 | 33.8 |
| | Si₃N₄ | 278.6 | 286.9 | 285 | 291.7 | 10 | 22 | −0.56 |
| | TOₓ | 10020 | 10030 | 10010 | 10030 | 10 | 22 | 0.5 |
| 1% by weight anh. | TEOS | 1010 | 1016 | 1018 | 1012 | 10 | 22 | −0.2 |
| HF in PC | OSG | 4195 | 4179 | 4194 | 4191 | 10 | 22 | −0.55 |
| | HSQ | 3258 | 3265 | 2902 | 2899 | 10 | 22 | 36.1 |
| | Si₃N₄ | 272.2 | 275.4 | 236.4 | 240.5 | 10 | 22 | 3.53 |
| | TOₓ | 9942 | 9943 | 9947 | 9929 | 10 | 22 | 0.45 |
| 2% by weight anh. | TEOS | 1020 | 1024 | 1018 | 1023 | 10 | 22 | 0.15 |
| HF in PC | OSG | 4237 | 4213 | 4229 | 4230 | 10 | 22 | −0.45 |
| | HSQ | 3248 | 3254 | 2461 | 2527 | 10 | 22 | 75.7 |
| | Si₃N₄ | 325 | 317.2 | 233.7 | 221.3 | 10 | 22 | 9.36 |
| | TOₓ | 9983 | 9985 | 9971 | 9970 | 10 | 22 | 1.3 |
| 5.11% by weight | TEOS | 1024 | 1028 | 1005 | 1004 | 10 | 22 | 2.39 |
| anh. HF in PC | OSG | 4295 | 4298 | 4296 | 4300 | 10 | 22 | −0.17 |
| | HSQ | 3277 | 3259 | 160 | 160 | 10 | 22 | 345.33 |
| | Si₃N₄ | 293.3 | 280.7 | 166.3 | 155.3 | 10 | 22 | 14.02 |
| | TOₓ | 9935 | 9931 | 9916 | 9920 | 10 | 22 | 1.67 |

From the data above, one can see that in order to remove the sacrificial dielectric (HSQ) at a reasonable rate, a high concentration of HF in PC must be used.

### Example 5

The effect of anhydrous vs. aqueous HF source and overall H₂O concentration on performance of a dual damascene post ash cleaner was evaluated by measuring TEOS etch rates and 193 nm photoresist removal rates of the formulations. Testing was carried out at 35° C. in a static bath. Pre and post measurements on the TEOS and photoresist films were carried out with a reflectometer in order to calculate etch rates.

In the first part of this example, the removal chemistry solution (which can also be interchangeably referred to as a “post ash cleaner”) was made from an anhydrous HF source by dissolving 7.5 g of a 0.5% (w/w) stock solution of HF (in a 50/50 (w/w) mixture of ethylene carbonate to propylene carbonate) into 15 g of 90% (w/w) lactic acid and 77.5 g of 50/50 (w/w) ethylene carbonate to propylene carbonate. The 0.5% by weight stock solution of HF in 50/50 (w/w) ethylene carbonate to propylene carbonate had been prepared by dissolving 125 g of 2% by weight anhydrous HF in propylene carbonate into 246.88 g of ethylene carbonate and 128.12 g propylene carbonate. The resulting post ash cleaner had a final composition of 0.03% by weight HF, 13.5% by weight lactic acid, 1.5% by weight water, 42.485% by weight ethylene carbonate and 42.485% by weight propylene carbonate.

An embodiment of the post ash cleaner was also made with aqueous HF by first diluting 49% by weight HF in water to 0.49% by weight in 50/50 (w/w) ethylene carbonate to propylene carbonate. 6.12 g of the resulting solution was dissolved into 15 g of 90% (w/w) lactic acid and 78.88 g of 50/50 (w/w) ethylene carbonate to propylene carbonate. The resulting post ash cleaner had a final composition of 0.03% by weight HF, 13.5% by weight lactic acid, 1.53% by weight water, 42.47% by weight ethylene carbonate and 42.47% by weight propylene carbonate.

| | | Exposure Time, | | | Etch Rate, | Average | Standard |
|---|---|---|---|---|---|---|---|
| Formulation | Film | min | Pre Thickness, Å | Post Thickness, Å | Å/min | Etch Rate | Deviation |
| 0.03% by weight | TEOS | 30 | 1021 | 982.5 | 1.3 | 1.5 | 0.4 |
| anhydrous HF, | | | 1026 | 989.1 | 1.2 | | |
| 13.5% by weight | | | 1056 | 996.6 | 2.0 | | |
| lactic acid in 50/50 | 193 nm | 5 | 2365 | 2017 | 69.6 | 68.1 | 2.0 |
| (w/w) ethylene | photoresist | | 2349 | 2020 | 65.8 | | |
| carbonate to | | | 2375 | 2030 | 69 | | |
| propylene carbonate | | | | | | | |
| 0.03% by weight | TEOS | 30 | 1043 | 993.4 | 1.7 | 1.4 | 0.3 |
| aqueous HF, 13.5% | | | 1027 | 994.6 | 1.1 | | |
| by weight lactic acid | | | 1042 | 1000 | 1.4 | | |
| in 50/50 (w/w) | 193 nm | 5 | 2377 | 2027 | 70 | 67.5 | 2.5 |
| ethylene carbonate to | photoresist | | 2359 | 2034 | 65 | | |
| propylene carbonate | | | 2368 | 2031 | 67.5 | | |

The etch rates are within error for each formulation, therefore there is no statistical difference in performance of the post ash cleaners when different HF sources are used.

In the second part of this example, increasing amounts of water are added to the post ash cleaner, and performance is once again evaluated as a function of TEOS etch rate and photoresist removal rate. The amounts of water evaluated were no additional water (1.5% by weight water in final formulation), 5% by weight water added (6.5% by weight water in final formulation), 10% by weight water added (11.5% by weight water in final formulation), 20% by weight water added (21.5% by weight in final formulation) and 50% water (51.5% by weight final formulation). For each of these formulations, the HF concentration was maintained at 0.03% by weight and the lactic acid concentration was maintained at 13.5% by weight. 50/50 (w/w) ethylene carbonate to propylene carbonate made up the remainder of solution.

| | | Exposure Time, | | | Etch Rate, | Average | Standard |
|---|---|---|---|---|---|---|---|
| Formulation | Film | min | Pre Thickness, Å | Post Thickness, Å | Å/min | Etch Rate | Deviation |
| 0.03% by weight | TEOS | 30 | 1021 | 982.5 | 1.3 | 1.5 | 0.4 |
| anhydrous HF, | | | 1026 | 989.1 | 1.2 | | |
| 13.5% by weight | | | 1056 | 996.6 | 2.0 | | |
| lactic acid, 1.5% | 193 nm | 5 | 2365 | 2017 | 69.6 | 68.1 | 2.0 |
| water in 50/50 (w/w) | photoresist | | 2349 | 2020 | 65.8 | | |
| ethylene carbonate to | | | 2375 | 2030 | 69 | | |
| propylene carbonate | | | | | | | |
| 0.03% by weight | TEOS | 30 | 1014 | 946.6 | 22 | 2.3 | 0.1 |
| anhydrous HF, | | | 1018 | 945.4 | 2.4 | | |
| 13.5% by weight | | | 1016 | 947.3 | 2.3 | | |
| lactic acid, 6.5% | 193 nm | 5 | 2375 | 2290 | 17 | 16.2 | 1.1 |
| water in 50/50 (w/w) | photoresist | | 2362 | 2285 | 15.4 | | |
| ethylene carbonate to | | | | | | | |
| propylene carbonate | | | | | | | |
| 0.03% by weight | TEOS | 30 | 1017 | 954.6 | 2.1 | 2.0 | 0.1 |
| anhydrous HF, | | | 1021 | 960.7 | 2.0 | | |
| 13.5% by weight | | | 1025 | 964.4 | 2.0 | | |
| lactic acid, 11.5% | 193 nm | 5 | 2372 | 2062 | 2 | 2.6 | 0.8 |
| water in 50/50 (w/w) | photoresist | | 2354 | 2338 | 3.2 | | |
| ethylene carbonate to | | | | | | | |
| propylene carbonate | | | | | | | |
| 0.03% by weight | TEOS | 30 | 1034 | 988.5 | 1.8 | 1.6 | 0.2 |
| anhydrous HF, | | | 1031 | 990.7 | 1.6 | | |
| 13.5% by weight | | | 1026 | 991.5 | 1.4 | | |
| lactic acid, 21.5% | 193 nm | 5 | 2392 | 2392 | 0 | −0.4 | 0.6 |
| water in 50/50 (w/w) | photoresist | | 2366 | 2072 | −0.8 | | |
| ethylene carbonate to | | | | | | | |
| propylene carbonate | | | | | | | |
| 0.03% by weight | TEOS | 30 | 1013 | 993.8 | 0.6 | 0.7 | 0.1 |
| anhydrous HF, | | | 1008 | 991.0 | 0.6 | | |
| 13.5% by weight | | | 1020 | 997.3 | 0.8 | | |
| lactic acid, 51.5% | 193 nm | 5 | 2362 | 2385 | −4.6 | −3.8 | 1.1 |
| water in 50/50 (w/w) | photoresist | | 2372 | 2387 | −3 | | |
| ethylene carbonate to | | | | | | | |
| propylene carbonate | | | | | | | |

The data shows that as the amount of water is increased, the TEOS etch rate initially increases, then decreases with increasing water concentration. The 193 nm photoresist removal rate drops significantly with increasing water, which is undesirable.

### Example 6

Copper blanket wafers are oxidized by heating in a convection oven open to the atmosphere at a temperature of 150° C. for 10 minutes. The treatment forms a bright pink oxide layer.

Wafers are then scribed into coupons, which are exposed to the cleaning formulation in an ultrasonic bath at 35° C. Chelators are either directly blended into the cleaning formulation, or if solubility is low, are first blended with another solvent such as water, acetic acid or an alcohol. Performance of the chelators is evaluated by measuring the time for the bright pink oxide layer to be visibly removed.

The results of these experiments are shown as follows:

| | Copper oxide removal time |
|---|---|
| Formulation | (min:sec) |
| 7% by weight Acetic Acid in 50/50 (w/w) ethylene carbonate to propylene carbonate | 38:30 |
| 7% by weight Acetic Acid, 0.05% by weight anh. HF in 50/50 (w/w) ethylene carbonate to propylene | >25:00 |
| carbonate | |
| 9.95% by weight Acetic Acid, 0.05% by weight anh. HF in 50/50 (w/w) ethylene carbonate to | 10:30 |
| propylene carbonate | |
| 7% by weight Lactic Acid in 50/50 (w/w) ethylene carbonate to propylene carbonate | 7:00 |
| 15% by weight Lactic Acid in 50/50 (w/w) ethylene carbonate to propylene carbonate | 2:22 |
| 15% by weight Lactic Acid, 0.03% by weight anh. HF in 50/50 (w/w) ethylene carbonate to propylene | 2:40 |
| carbonate | |
| 7% by weight Lactic Acid, 7% by weight Acetic Acid, 0.05% by weight anh. HF in 50/50 (w/w) | 4:08 |
| ethylene carbonate to propylene carbonate | |
| 3.5% by weight Maleic Acid in 50/50 (w/w) ethylene carbonate to propylene carbonate | 4:35 |
| 3.5% by weight Maleic Acid; 3.5% by weight Acetic acid in 50/50 (w/w) ethylene carbonate to | 1:51 |
| propylene carbonate | |
| 3.5% by weight Maleic Acid; 7% by weight Acetic acid in 50/50 (w/w) ethylene carbonate to | 3:30 |
| propylene carbonate | |
| 3.5% by weight Maleic Acid; 3.5% by weight Lactic acid in 50/50 (w/w) ethylene carbonate to | 1:29 |
| propylene carbonate | |
| 0.22% by weight N-(2-(acetamido)imino)diacetic acid | 0:35-0:40 |
| (ADA); 20% by weight H2O in 50/50 (w/w) ethylene carbonate to propylene carbonate | |
| 6.8% by weight 1,2,4,5-benzenetetracarboxylic acid, 13.8% by weight H2O in 50/50 (w/w) ethylene | 1:00 |
| carbonate to propylene carbonate | |
| 6.6% by weight Citric Acid, 3.4% by weight H2O in 50/50 (w/w) ethylene carbonate to propylene | 5:00 |
| carbonate | |
| 1.75% by weight Gluconic Acid, 13.55% by weight H2O in 50/50 (w/w) ethylene carbonate to | <1:00 |
| propylene carbonate | |
| 0.22% by weight Iminodiacetic acid; 20% by weight H2O in 50/50 (w/w) ethylene carbonate to | 0:51-0:56 |
| propylene carbonate | |
| 6% by weight malic acid in 50/50 (w/w) ethylene carbonate to propylene carbonate | >30:00 |
| 7% by weight Oxalic Acid in 50/50 (w/w) ethylene carbonate to propylene carbonate | >50:00 |
| 2% by weight Succinic Acid; 7% by weight ethanol in 50/50 (w/w) ethylene carbonate to propylene | >15:00 |
| carbonate | |
| 7% by weight Tartaric Acid, 20.4% by weight H2O in 50/50 (w/w) ethylene carbonate to propylene | 0:25 |
| carbonate | |
| 6.3% by weight THF-Tetracarboxylic acid; 6.6% by weight H2O in 50/50 (w/w) ethylene carbonate to | 3:00 |
| propylene carbonate | |
| 3% by weight Trifluoroacetic acid, 0.05% by weight anh. HF in 50/50 (w/w) ethylene carbonate to | 2:00 |
| propylene carbonate | |
| 7% by weight Acetic Acid, 2.5% by weight H3PO4, 0.05% by weight anh. HF in 50/50 (w/w) ethylene | 2:51 |
| carbonate to propylene carbonate | |
| 7% by weight Acetic Acid, 10% by weight H3PO4, 0.05% by weight anh. HF in 50/50 (w/w) ethylene | 0:13 |
| carbonate to propylene carbonate | |

From the data it is observed that the formulation containing 10% by weight phosphoric acid had the quickest copper oxide removal time.

### Example 7

This Example shows solutions and their effectiveness when using co-solvents in the solution. The addition of a co-solvent improves the miscibility of the solution or formulation with water to give enhanced rinsing, such as shown below:

| | Amount of formulation | | Amount of water miscible in | |
|---|---|---|---|---|
| | at left miscible in 20 g | Time it takes formulation | 20 g of formulation at left (at | Time it takes water to |
| Formulation | H2O (at 20° C.) | to dissolve in water | 20° C.) | dissolve in formulation |
| Propylene carbonate | 4.7110 g | 10-30 sec per aliquot | 1.4932 g | 10-30 sec per aliquot |
| 0.75% by weight anh. HF | 5.6092 g | 10-30 sec per aliquot | 5.5474 g | 10-30 sec per aliquot |
| 9.25% by weight Acetic acid | | | | |
| 90% by weight propylene | | | | |
| carbonate | | | | |
| 0.75% by weight anh. HF | 20 g + Completely | <5 sec | 20 g + Completely | <5 sec |
| 9.25% by weight Acetic acid | miscible | | miscible | |
| 40% by weight propylene | | | | |
| carbonate | | | | |
| 50% by weight Ethylene | | | | |
| carbonate | | | | |

From the data it is observed that the addition of a water miscible co-solvent enhances both miscibility and dissolution time of the formulation in water and vise versa. This is a desirable feature of the formulation for high volume manufacturing, where a quick and effective aqueous rinse step is preferred.

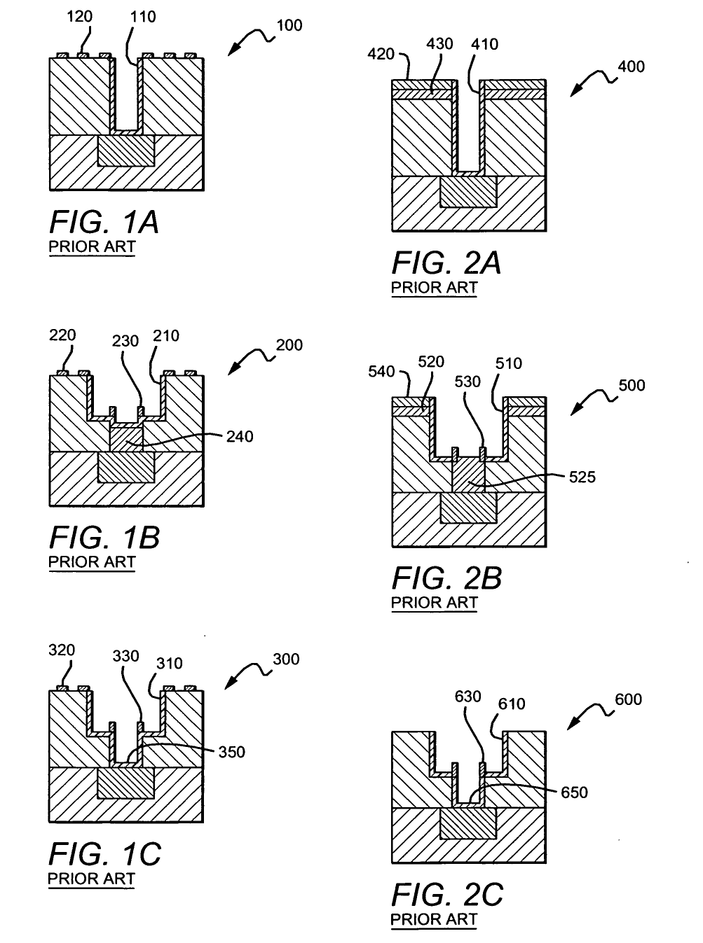

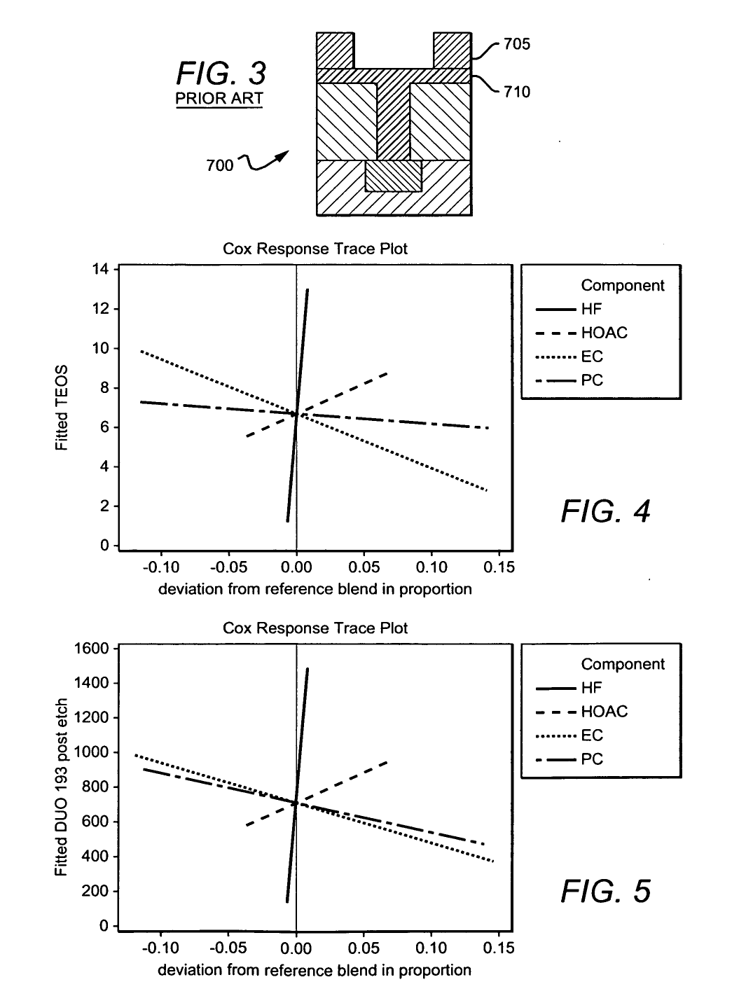

FIGS. 4 and 5 show Cox Response Trace Plots for co-solvent solutions, such as those contemplated herein. In FIG. 4, the trace lines represent the effect of change in component concentration from the reference point on the etch rate of TEOS. The increase in concentration of ethylene carbonate (EC) significantly decreases the etch rate of TEOS, while propylene carbonate (PC) has only a slight influence on the etch rate. This combination of solvents shows higher selectivity towards removal of sacrificial materials, such as sacrificial BARCs (DUO™). In FIG. 5, the trace lines represent the effect of change in the component concentration from the reference point on the etch rate of plasma damaged DUO™ 193. The increase in concentration of both solvents acts to decrease plasma damaged DUO™ 193 etch rate (dilution effect).

### Example 8

In this example, the effect of temperature on etch rates of dielectric films was tested for two different formulations. The formulation, MLL111505, comprised 0-1% by weight HF, 0-5% by weight maleic acid, with the balance consisting of a 50/50 (w/w) blend of gamma-butyrolactone and propylene carbonate. The second formulation, DLY111505, comprised by 0-1% by weight HF, 0-20% by weight phosphoric acid, 0-10% by weight acetic acid, with the balance consisting of a 50/50 (w/w) blend of gamma-butyrolactone and propylene carbonate. Tests were conducted without agitation at 35, 45, and 55° C.

Materials Etch Data for MLL111505

| | Temp | Ave Etch Rate* |
|---|---|---|
| Material | (° C.) | (A/min) |
| TEOS | 35 | 0.71 |
| | 45 | 1.4 |
| | 55 | 2.5 |
| FSG | 35 | 0.32 |
| | 45 | 1.0 |
| | 55 | 0.87 |
| OSG | 35 | 0.55 |
| | 45 | 0.25 |
| | 55 | 1.2 |
| SiCN | 35 | 0.38 |
| | 45 | 0.5 |
| | 55 | 0.21 |

*Average of at least 2 measurements

Materials Etch Data for DLY111505

| | Temp | Ave Etch Rate* |
|---|---|---|
| Material | (° C.) | (A/min) |
| TEOS | 35 | 3.0 |
| | 45 | 4.2 |
| | 55 | 5.2 |
| FSG | 35 | 1.4 |
| | 45 | 3.7 |
| | 55 | 5.7 |
| OSG | 35 | 0.33 |
| | 45 | 1.4 |
| | 55 | 0.4 |
| SiCN | 35 | <0.1 |
| | 45 | <0.1 |
| | 55 | <0.1 |

*Average of at least 2 measurements

For either formulation, etch rates of the dielectric materials tested do not increase significantly with temperature, or do not increase at all (no obvious correlation for temperatures tested). This is desirable as it allows a larger process window for which temperatures can be adjusted to aid in residue removal without having a deleterious effect on the materials that are to remain.

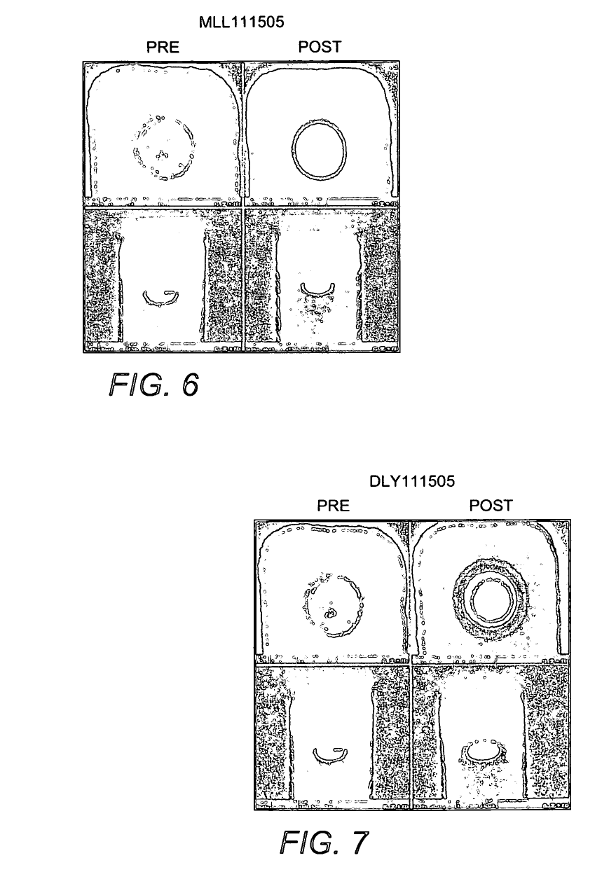

For contemplated formulations identified as MLL111505 and DLY111505 listed above, the pre and post exposure coupons are shown in FIGS. 6 and 7. These dual damascene wafer coupons were processed for 60 seconds at 35 ° C. at 200 RPM with a 1 L/min chemical dispense rate.

Thus, specific embodiments and applications of selective etching and cleaning solutions for semiconductor and electronic applications, these solutions manufacture and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized or combined with other elements, components, or steps that are not expressly referenced.

We claim:

1. A removal chemistry solution, comprising:
at least one fluorine-based constituent,
at least one chelating component, surfactant component, oxidizing component or combination thereof; and
at least one solvent or solvent mixture.

2. The removal chemistry of claim 1, comprising at least two chelating components, surfactant components, oxidizing components or a combination thereof.

3. The removal chemistry of claim 1, wherein the at least one chelating component comprises an organic acid, an amine, a phosphonate, a sulfonic acid, H₃PO₄ or a combination thereof.

4. The removal chemistry solution of claim 3, wherein the chelating component comprises acetic acid, citric acid, malic acid, lactic acid, oxalic acid, tartaric acid, N-(2-(acetamido)imino)diacetic acid, 1,2,4,5-benzenetetracarboxylic acid, gluconic acid, iminodiacetic acid, succinic acid, THF-tetracarboxylic acid, trifluoroacetic acid, maleic acid, H₃PO₄ or a combination thereof.

5. The removal chemistry of claim 1, wherein the at least one fluorine-based constituent comprises at least one aqueous fluorine-based constituent, at least one low H₂O content fluorine-based constituent or a combination thereof.

6. The removal chemistry of claim 5, wherein the at least one fluorine-based constituent comprises any suitable fluoride source, including R₁R₂R₃R₄NF, where R₁, R₂, R₃ and R₄ can be the same or different and can be H or any hydrocarbon moiety of 10 or less carbon units and may be aliphatic, aromatic or cyclic.

7. The removal chemistry of claim 6, wherein the at least one fluorine-based constituent comprises ammonium fluoride, tetramethylammonium fluoride, tetrabutylammonium fluoride, tetraethylammonium fluoride or benzyltrimethylammonium fluoride; hydrogen fluoride, pyridine hydrogen fluoride, ammonium bifluoride or combinations thereof.

8. The removal chemistry solution of claim 1, wherein the at least one solvent or solvent mixture comprises propylene carbonate, butylene carbonate, ethylene carbonate, gamma-butyrolactone, N-methyl-2-pyrrolidone, propylene glycol, ethylene glycol, ethyl lactate, N,N-dimethylacetarnide, propylene glycol monomethyl ether acetate, dimethyl sulfoxide, pyridine or a combination thereof.

9. The removal chemistry solution of claim 1, wherein the solution comprises HF, maleic acid, acetic acid, γ-butyrolactone and propylene carbonate.

10. The removal chemistry solution of claim 1, wherein the removal chemistry solution has a selective removal of copper oxide to copper of greater than about 100:1.

11. The removal chemistry solution of claim 1, wherein the removal chemistry solution substantially completely removes a copper oxide layer from a substrate or layered material.

12. A method of producing a removal chemistry solution, comprising:
providing at least one fluorine-based constituent,
providing at least one chelating component, surfactant component, oxidizing component or combination thereof,
providing at least one solvent or solvent mixture, and
combining the at least one fluorine-based constituent and the at least one fluorine-based constituent, the at least one chelating component, surfactant component, oxidizing component or combination thereof with the at least one solvent or solvent mixture to form the removal chemistry solution.

13. The method of claim 12, wherein the at least one chelating component comprises an organic acid, an amine, a phosphonate, a sulfonic acid, H₃PO₄ or a combination thereof.

14. The method of claim 13, wherein the chelating component comprises acetic acid, citric acid, malic acid, lactic acid, oxalic acid, tartaric acid, N-(2-(acetamido)imino)diacetic acid, 1,2,4,5-benzenetetracarboxylic acid, gluconic acid, iminodiacetic acid, succinic acid, THF-tetracarboxylic acid, trifluoroacetic acid, maleic acid, H₃PO₄ or a combination thereof.

15. The method of claim 14, wherein the at least one fluorine-based constituent comprises any suitable fluoride source, including R₁R₂R₃R₄NF, where R₁, R₂, R₃ and R₄ can be the same or different and can be H or any hydrocarbon moiety of 10 or less carbon units and may be aliphatic, aromatic or cyclic.

16. The method of claim 12, wherein providing the at least one solvent or solvent mixture comprises providing propylene carbonate, butylene carbonate, ethylene carbonate, gamma-butyrolactone, N-methyl-2-pyrrolidone, propylene glycol, ethylene glycol, ethyl lactate, N,N-dimethylacetamide, propylene glycol monomethyl ether acetate, dimethyl sulfoxide, pyridine or a combination thereof.

17. A removal chemistry solution produced by the method of claim 12.

18. A removal chemistry solution, comprising:
at least one fluorine-based constituent,
at least one chelating component comprising acetic acid and maleic acid; and
at least one solvent mixture comprising propylene carbonate and γ-butryolactone.
